(19) United States
(12) Patent Application Publication
(10) Pub. No.: US 2009/0288310 A1
(43) Pub. Date: Nov. 26, 2009

(54) System and Method for Radiation-Hardening a Coating of a Workpiece Under a Protective Gas

(76) Inventors: Wilhelm Sturm, Hankofen (DE); Josef Wallner, Irlbach (DE)

Correspondence Address: JACOBSON HOLMAN PLLC, 400 SEVENTH STREET N.W., SUITE 600, WASHINGTON, DC, 20004, US

(21) Appl. No.: 12/083,828

(22) PCT Filed: Oct. 17, 2006
(86) PCT No.: PCT/EP2006/010016

§ 371 Date: Apr. 18, 2008

(30) Foreign Application Priority Data
Oct. 20, 2005 (DE) 10 2005 050 371.3

(51) Int. Cl. F26B 3/34; F26B 19/00

(52) U.S. Cl. 34/275; 34/236

(57) ABSTRACT

The invention relates to a plant for the radiation hardening of a coating of a workpiece under protective or inert gas, with a hardening cabin or booth, on which is provided at least one irradiating device for irradiating the cabin or booth interior, and a conveyor for conveying the workpiece into the hardening cabin along a conveying path. In the vicinity of the hardening cabin and at the ceiling thereof is formed a collecting area where, compared with the surrounding atmosphere, lighter protective gas collects and that the conveying path of the workpiece passes through the collecting area located at the ceiling. The invention also relates to a method for the radiation hardening of a coating of a workpiece under protective gas.

The invention relates to a plant for the radiation hardening of a coating of a workpiece under inert or protective gas according to the preamble of claim 1. Such a plant can have a hardening cabin or booth, on which is provided at least one irradiating device for irradiating the workpiece in the cabin or booth interior, as well as a conveyor for conveying the workpiece in the hardening cabin.

The invention also relates to a method for the radiation hardening of a coating of a workpiece under protective gas according to the preamble of claim 1, in which the workpiece is conveyed into a hardening cabin, where it is irradiated.

Such a plant and method are e.g. known from DE 202 03 407 U1. In the known plant the carbon dioxide-containing protective gas is filled into a floor tank of the plant, so that a protective gas bath is formed. On the floor tank are provided UV light sources for irradiating the workpiece.

On operating the known plant the workpieces are immersed along a conveyor belt in the protective gas-filled floor tank. The workpieces then horizontally traverse the floor tank and are irradiated by the UV light sources. After passing through the irradiation zone in the floor tank the workpieces are again removed from the floor tank and raised from the protective gas.

According to the prior art carbon dioxide is preferably used as the protective gas. In the case of operating problems, particularly when the floor tank is overfilled, in unfavourable cases said carbon dioxide can flow out of said floor tank and pass from there into adjacent plant parts or flow entirely out of the plant. In such a case, the carbon dioxide can sometimes lead to a health hazard for workers in the vicinity.

The object of the invention is to provide a plant and a method for the radiation hardening of a coating of a workpiece under protective gas which are particularly safe and at the same time economic and reliable.

The object is achieved by a plant having the features of claim 1 and by a method having the features of claim 11. Preferred embodiments are given in the dependent claims.

The inventive plant is characterized in that in the vicinity of the hardening cabin a collecting area is formed on the roof or ceiling thereof, in which is collected lighter protective gas compared with the surrounding atmosphere, that the conveying path of the workpiece passes through the collecting area and that the at least one irradiating device is positioned along the collecting area.

A first fundamental idea of the invention involves the use of a protective gas, which is lighter than the surrounding atmosphere, i.e. is less dense. Said protective gas is not enriched on the floor of the hardening cabin and instead rises towards the ceiling of said cabin. Thus, according to the invention, irradiation under protective gas does not take place in an upwardly open floor or dipping tank in the floor area of the plant, but instead in a top-closed, generally bottom-open collecting area on the ceiling of the hardening cabin. For this purpose the workpiece conveying path passes through the ceiling-side collecting area and the irradiating device is also located in the ceiling area in the vicinity of the collecting area.

The use of a protective gas which is lighter than the surrounding atmosphere has important advantages from the worker protection standpoint. If, e.g. as a result of an operating problem, there is an accidental overfilling of the plant, the escaping gas does not initially collect on the floor of surrounding rooms but instead in the ceiling area. However, at this point it does not generally constitute a hazard for workers and can be detected at an early stage by ceiling sensors. The inventive plant and method are consequently particularly safe.

The inventive collecting area can in particular be formed by a ceiling tank, i.e. an inverted floor tank, which is sealed upwards and to the sides and open downwards, i.e. towards the floor. The collecting area can also in part have a sealed surface towards the floor for even better protective gas concentration and in the floor-side surface there can be at least one passage opening for the conveyor. For the lateral inclusion of the gas, it is in particular possible for the height of the ceiling compared with the ground to be greater in the collecting area than the height of the ceiling in the neighbouring areas outside the collecting area.

The invention can in particular be used for UV radiation hardening, the irradiating device then being used for producing UV radiation. According to the invention the conveyor can e.g. be an overhead or a floor-level conveyor.

For introducing the workpiece into the collecting area, it is fundamentally possible to provide laterally in the collecting area lock mechanisms, which prevent a lateral protective gas outflow from the collecting area, but still allow a workpiece passage. In this case, the conveying path can enter the collecting area substantially horizontally. However, according to the invention, a particularly easily designed plant results from the conveying paths rising into the collecting area. In this case the conveying path is not horizontal, but instead slopes with respect to the horizontal out of the collecting area environment into the collecting area and then optionally out of said collecting area again. This makes it possible to provide the collecting area with solid side walls, without requiring a lock, so that with a simple plant design a particularly reliable gas inclusion in the collecting area is ensured. It is also possible for the conveying path to rise perpendicularly into the collecting area. According to the invention, a particularly reliable and safe plant is obtained in that the collecting area is located in an upper apex of the conveying path, i.e. the conveying path reaches its highest points in the collecting area.

For a particularly high workpiece throughput, the conveying path appropriately has an entry path section on which the workpieces enter the collecting area, as well as a discharge path section spatially separated therefrom and on which the workpieces pass out of the collecting area. This ensures a continuous workpiece conveying through the collecting area. With particular preference both the entry path section and the discharge path section are inclined to the horizontal. The workpieces can also move on one and the same conveying path section into and out of the collecting area.

A particularly economic and reliable plant is obtained according to the invention in that to the hardening cabin is connected at least one conveying tunnel for supplying and/or removing the workpiece into or from the hardening cabin. Said conveying tunnels are traversed by the conveying path. There are preferably two conveying tunnels for the hardening cabin, one being used for supplying the workpiece to the hardening cabin and the other for removing the workpiece therefrom.

The inventive collecting area can in particularly simple manner be formed in that the height of the ceiling relative to the floor increases in the conveying tunnel towards the hardening cabin. Thus, in particular the ceiling height rises along the conveying path to the collecting area. According to this embodiment the collecting area is sealed laterally along the conveying path by sloping ceiling elements. Advantageously the ceiling elements of the two conveying tunnels and the hardening cabin and/or the conveying path at least approximately form an inverted V-shape in the vicinity of the said cabin, the ceiling elements and the path running sectionwise approximately horizontally in the apex. For the lateral bounding of the collecting area towards the conveying tunnel it is possible to provide on the ceiling or roof of the hardening cabin and/or the conveying tunnel bulkhead partitions running downwards from the ceiling, e.g. roughly vertically downwardly running boundary plates, the ceiling height on either side of the plates being roughly identical.

The collecting area is preferably laterally towards the conveying path sealed by wall elements sloping with respect to the vertical. Appropriately said wall elements, which in particular result from the conveying tunnel ceiling elements, run under an angle between 30 and 60ø, preferably approximately 45ø to the horizontal. This particularly effectively prevents undesired gas turbulence in the collecting area, which can lead to undesired concentration fluctuations through gas flowing back into the collecting area. The collecting area can in principle also be bounded laterally by roughly vertically directed wall elements. Such vertical wall elements can in particular be provided for bounding transversely to the conveying direction.

A particularly reliable gas filling of the collecting area can result from the provision on the hardening cabin, particularly its ceiling area, of at least one supply opening for supplying protective gas. Preferably the protective gas is supplied in the actual collecting area, particularly on the ceiling-side, into the chamber, because this particularly reliably prevents undesired gas turbulence and/or intermixing with ambient gas. In principle, the protective gas could also be supplied outside the collecting area and optionally the hardening cabin, from where as a result of its buoyancy it flows into the collecting area. It is also advantageous for preventing undesired gas turbulence for there to be several supply openings, which are in particular formed in large-area manner, e.g. as supply slots. It is fundamentally possible to introduce the protective gas discontinuously, particularly as a function of a concentration and/or level measurement in the collecting area. A continuous gas introduction is also possible. to avoid overfilling of the collecting area there can also in this case be a continuous gas removal in the area round the collecting area, particularly below the latter.

According to another preferred embodiment of the invention in the ceiling area of the hardening cabin there is at least one gas sensor. The gas sensor can e.g. be a protective gas sensor and/or an environmental gas sensor. The gas sensor can be positioned in the collecting area and/or its surrounding areas in order to monitor the filling state of the collecting area. The gas sensor can in particular be constructed as an oxygen sensor. Thus, particular significance can be attached to a determination of the oxygen content in the collecting area, because oxygen can greatly impede the radiation hardening process.

Preferably there is at least one gas lock along the conveying path, which particularly effectively prevents an extraneous gas invasion of the collecting area. The gas lock can e.g. be located in the conveying tunnel, where it can prevent harmful gas flows through the said tunnel into the collecting area. However, the collecting area can also be directly laterally bounded by a gas lock. The at least one gas lock can e.g. have a nozzle curtain. Additionally or alternatively it is possible to e.g. provide a curtain of flexible flaps, e.g. plastic flaps.

Appropriately a painting cabin or booth is located on the conveying path. Said painting cabin contains painting devices for applying the coating to be hardened. Preferably there is an air conditioning installation for adjusting the humidity of the gas contained in the painting cabin. The air conditioning installation can in particular be constructed as a drying installation. This embodiment is based on the finding that atmospheric humidity can in particular enter the coating during its application process, where it forms a type of barrier layer, which can prevent a complete hardening. By controlling the atmospheric humidity in the painting cabin, the barrier layer formation tendency can be reduced and/or eliminated. It is in particular possible to blow predried air into the painting cabin for this purpose. The atmospheric humidity in the painting cabin is preferably roughly 40% or less.

As even after the end of the coating process and prior to the final curing atmospheric humidity can penetrate the coating, it is advantageous to also control the gas humidity in the area between the painting cabin and the hardening cabin. To this end there is advantageously a device for adjusting the gas humidity in the conveying tunnel. Appropriately conditioned, i.e. predried air is continuously or discontinuously blown into the conveying tunnel and/or the painting cabin. The use of predried air is particularly necessary with high coating thicknesses. The control of the atmospheric humidity during the coating process and during conveying between painting cabin and irradiation area and/or the regulation or adjustment of a precisely defined atmospheric humidity can be looked upon as an independent inventive aspect.

The protective gas can in particular be carbon dioxide (CO2) and/or nitrogen (N2). The surrounding atmosphere is typically air. If use is made of a protective gas which for the same temperature has a higher or only slightly lower density than the surrounding atmosphere, according to the invention the protective gas is heated in comparison with the surrounding atmosphere, which involves a density reduction of the protective gas relative to the surrounding or ambient gas. For this purpose a heating device for protective gas heating is provided. By heating the protective gas it is also possible to collect in the ceiling-side collecting area a protective gas which is otherwise heavier than the surrounding atmosphere for the same temperature.

A particularly reliable operation of the plant is ensured by the protective gas being heated prior to its release in the hardening cabin and for this purpose the heating device is appropriately located outside said cabin. However, in principle the protective gas can also be heated inside the hardening cabin and for this purpose lamps can e.g. be provided. In this case during introduction the protective gas can have roughly the same temperature as the ambient gas. In particular the irradiating device, which irradiates the workpiece for curing the coating, can be simultaneously used for gas heating. Particularly economic operation is possible with a protective gas temperature between 40 and 100øC, particularly between 50 and 80ø. The ambient gas is preferably at room temperature.

The invention is particularly suitable for working large workpieces, e.g. complete axle groups for cars, lorries or trucks. In order to bring about reliable curing of the coating even in the case of undercut workpieces, it is advantageous for the workpiece to be movable relative to the radiating system in the hardening cabin. For this purpose the conveyor has at least one pivotable work holder for pivoting the workpiece in the hardening cabin. Advantageously the work holder is pivotable in at least two and in particular three axes. Alternatively or additionally the irradiating device has itself a movable radiating system for modifying the irradiation angle of the workpiece. It is in particular possible to pivot the radiating system for modifying the direction in space of an emitted beam. To this end the radiating system can also have a pivotable reflector.

For a UV radiation hardening method the irradiating device preferably has UV radiating systems. The at least one radiating system of the irradiating device can be located in the irradiating cabin. However, the radiating system can also be located outside the hardening cabin and said cabin then has windows through which the radiation can enter the cabin. For this purpose there are preferably radiation-transparent panes in the windows, particularly in the collecting area. The windows are appropriately elongated and extend in or transversely to the workpiece conveying direction. The radiating systems are advantageously constituted by tubular radiating systems. The radiating systems appropriately have reflectors.

For increasing hardening efficiency it is advantageous for the inner walls of the hardening cabin to at least zonally be provided with a reflecting material. To ensure that undercut components are also well cured, it is preferable in this connection that the reflecting material leads to a diffuse reflection, so that as a function of the point of incidence of a light beam striking the wall reflection back into another direction occurs. To this end the reflecting material can have a reflecting coating, whose angular position along the wall varies regularly or irregularly.

Advantageously the reflecting material is only provided in the collecting area, so that a radiation reflection from said area and therefore an uncontrolled hardening outside the collecting area is avoided. Preferably the inner walls absorb rays in regions outside the collecting area and/or outside the hardening cabin, i.e. are darkened or blackened. An absorbing inner wall is particularly advantageous in the supply area between the painting installation and the hardening cabin, because there the coating has still not cured. In order to reduce extraneous light influences the hardening cabin is preferably darkened.

There could also be independent inventive aspects with regards to the construction of the conveyor, irradiating device and inner plant walls.

The inventive method is characterized in that a less dense protective gas compared with the surrounding atmosphere and in particular nitrogen is introduced into the hardening cabin and collects in a collecting area at the ceiling or roof of said cabin, and that the workpiece is conveyed through the collecting area in the vicinity of the ceiling and is irradiated therein.

The method can in particular be performed with an inventive plant and the advantages explained in this connection are obtained.

It is also possible according to the invention for the workpieces to be conveyed at least approximately horizontally into the hardening cabin and for curing purposes are raised at least approximately vertically into the protective gas atmosphere in the collecting area in the vicinity of the ceiling. In the case of the inventive conveyor for conveying the workpiece it can in particular be an automatic revolving transfer and/or chain machine.

The invention is explained in greater detail hereinafter relative to a preferred embodiment and the attached diagrammatic drawing, wherein shows:

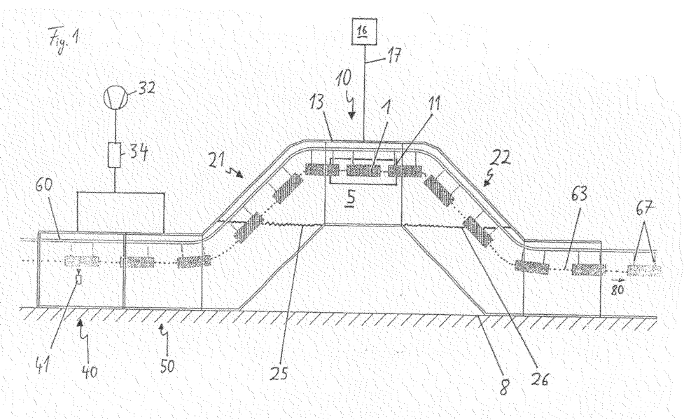

FIG. 1 A diagrammatic view of an inventive radiation hardening plant for performing the method according to the invention.

A plant for the radiation hardening of the coating of workpieces under a protective or inert gas is shown in FIG. 1. The plant has a conveyor 60 in the form of an overhead conveyor, on which the workpieces 1 are suspended by means of pivotable work holders 67. The conveyor 60 conveys the workpieces 1 along a conveying path 63, shown in dotted line form, through the plant in conveying direction 80.

At the entrance side of the plant is provided a painting booth or cabin 40, in which the workpieces 1 are provided with a coating to be cured by means of a coating device 41. A fan 32 for ventilating the painting cabin 40 is provided on the latter. On the ventilating line is provided an air dehumidifier 34 for predrying the air blown into the painting cabin 40.

From painting cabin 40 the workpieces 1 on conveying path 63 pass into a connecting passage 50, into which is also blown air predried by air dehumidifier 34. From connecting passage 50 the workpieces 1 continue on conveying path 63 into a first conveying tunnel 21 and from there into hardening cabin or booth 10. In hardening cabin 10 the workpieces 1 are irradiated with UV light for curing the coating. The UV light is produced by not shown radiating systems within the hardening cabin 10 and/or produced outside said hardening cabin 10 and irradiated through windows 11 into the interior of cabin 10. The workpieces 1 are removed from hardening cabin 10 via a second conveying tunnel 22.

According to the invention curing, i.e. UV irradiation, takes place under a protective or inert gas atmosphere. For the supply of the protective gas a supply line 17 supplied with protective gas from a reservoir 16 terminates at the ceiling 13 of hardening cabin 10.

Starting from the painting cabin 10 the height of the ceiling 13 with respect to the ground 8 increases along the conveying path 63 to cabin 10. The ceiling 13 is roughly horizontal in hardening cabin 10. In the following discharge-side conveying tunnel 22, the height of the ceiling 13 relative to the ground 8 decreases with increasing distance from the hardening cabin 10. As a result of this ceiling structure in the section along the conveyor 80, in said plant is formed an inverted trough structure, in whose upper region is formed a collecting area 5 for the protective gas. Laterally and perpendicular to the conveying direction 80, i.e. perpendicular to the drawing plane, the collecting area is bounded by not shown, vertical side wall elements of conveying tunnels 21, 22 and hardening cabin 10 running perpendicular to the ground 8.

According to the invention use is made of a protective gas which is lighter than the ambient gas in the remaining plant parts. Within the plant said protective gas rises and collects in collecting area 5. Thus, in the apex of the plant is formed a protective gas pocket in which UV curing takes place. This protective gas pocket is bounded relative to the surrounding atmosphere in conveying tunnels 21/22 in boundary areas 25 and 26. As two different gas phases meet one another in boundary areas 25, 26, the latter are not generally sharply defined.

In the embodiment shown the floor in conveying tunnels 21, 22 and hardening cabin 10 along conveying path 63 is roughly parallel to the ceiling 13. However, as according to the invention the extension of the collecting area is essentially defined by the ceiling shape, the path of the floor in the conveying tunnels 21, 22 and hardening cabin 10 can be freely varied without any significant functionality loss. In particular, the height of the floor relative to the ground 8 can be roughly constant in conveying tunnels 21, 22 and hardening cabin 10.

After passing through the painting cabin 40, the conveying path 63 in conveying tunnel rises upwards, so that the workpieces 1 enter the protective gas pocket formed on the ceiling-side in collecting area 5. In the hardening cabin 10 in which irradiation takes place, the conveying path 63 runs roughly horizontally through collecting area 5 at window 11. In the discharge-side conveying tunnel 22 the height of the conveying path decreases again with increasing distance from hardening cabin 10, so that after curing has taken place the workpieces 1 again pass out of the ceiling-side, protective gas-filled collecting area 5.

1-11. (canceled)

12. Plant for the radiation hardening of a coating of a workpiece (1) under protective gas, having
a hardening cabin (10) on which is provided at least one irradiating device for irradiating the cabin interior and
a conveyor (60) for conveying the workpiece (1) in the hardening cabin (10) along a conveying path (63),
characterized in that
in the vicinity of the hardening cabin (10) on the ceiling (13) thereof is formed a collecting area (5) in which, compared with the surrounding atmosphere, lighter protective gas collects,
the conveying path (63) of the workpiece (1) passes through the collecting area (5) and
the at least one irradiating device is positioned along the collecting area (5).

13. Plant according to claim 12, characterized in that the conveying path (63) rises into the collecting area (5).

14. Plant according to claim 12, characterized in that the hardening cabin (10) is followed by at least one conveying tunnel (21, 22) for supplying and/or removing the workpiece (1) into or from the hardening cabin (10) and that the height of the ceiling (13), relative to the ground (8), in the conveying tunnel (21, 22) rises towards the hardening cabin (10).

15. Plant according to claim 12, characterized in that on the hardening cabin (10), particularly on its ceiling area, is provided at least one supply opening for supplying protective gas.

16. Plant according to claim 12, characterized in that there is at least one gas sensor in the ceiling area of hardening cabin (10).

17. Plant according to claim 12, characterized in that there is at least one gas lock along the conveying path (63).

18. Plant according to claim 12, characterized in that a painting cabin (40) is provided on the conveying path (63) and that an air conditioning installation for adjusting the humidity of the gas contained in painting cabin (40) is provided.

19. Plant according to claims 12, characterized in that a heating device is provided for heating the protective gas.

20. Plant according to claim 12, characterized in that the conveyor (60) has at least one pivotable work holder (67) for pivoting workpiece (1) in the hardening cabin (63) and/or the irradiating device has at least one displaceable radiating system for varying the irradiation angle of workpiece (1).

21. Plant according to claim 12, characterized in that the inner walls of the hardening cabin (10) are at least zonally provided with a reflecting material.

22. Method for the radiation hardening of a coating of a workpiece (1) under protective gas, particularly in a plant according to claim 12, in which
the workpiece is conveyed into a hardening cabin (10) where it is irradiated,
characterized in that
a protective gas less dense than the surrounding atmosphere and in particular nitrogen is introduced into the hardening cabin (10) and collects in a collecting area (5) at the ceiling of the hardening cabin (10) and
the workpiece is conveyed through the ceiling-side collecting area (5) and is irradiated therein.
